(19) United States
(12) Patent Application Publication
(10) Pub. No.: US 2009/0106025 A1
(43) Pub. Date: Apr. 23, 2009

(54) SPEAKER MODEL REGISTERING APPARATUS AND METHOD, AND COMPUTER PROGRAM

(75) Inventor: Soichi Toyama, Saitama (JP)

Correspondence Address: YOUNG & THOMPSON, 209 Madison Street, Suite 500, ALEXANDRIA, VA, 22314, US

(73) Assignee: PIONEER CORPORATION, TOKYO (JP)

(21) Appl. No.: 12/293,943

(22) PCT Filed: Mar. 16, 2007
(86) PCT No.: PCT/JP2007/055433

§ 371 Date: Nov. 20, 2008

(30) Foreign Application Priority Data
Mar. 24, 2006 (JP) 2006-084275

(51) Int. Cl. G10L 17/00

(52) U.S. Cl. 704/250; 704/E17.006

(57) ABSTRACT

EN) A speaker recognition system (1) includes a speaker model registration device (10) which registers a speaker model for speaker recognition in the speaker recognition system. The speaker model registration device includes acquisition means (13) for acquiring utterances by n+α times (wherein n is an integer not smaller than 2 and α is an integer not smaller than 1); calculation means (20) for calculating a speaker model by using the acquired utterances of n times as utterances for registration; correlation means (30) for correlating the calculated speaker model by using the acquired utterances of α times as correlation utterances; and registration means (40) for registering those having the correlation result satisfying a predetermined reference among the correlated speaker models, as the speaker model for speaker recognition.

### TECHNICAL FIELD

The present invention relates to a speaker recognition system, which is provided for various computer equipment and various electronic electric equipment, such as a car navigation apparatus, a net banking apparatus, an auto-lock apparatus, and a computer's recognizing apparatus, and which performs speaker recognition on the basis of an utterance of a speaker who is a user of the system. In particular, the present invention relates to a speaker model registering apparatus and method in the system, and a computer program which makes a computer function as such a speaker model registering apparatus.

### BACKGROUND ART

This type of speaker model registering apparatus has three types of systems: of a text fixed type or text dependence type in which an uttered text used for the recognition is registered in advance; of a text independent type or non-text-dependence type in which the above registration is not required and recognition is performed on an arbitrary text, and of a text specification type in which the text is specified for the recognition in the registration or in each recognition. Of these, the text dependence type reaches practical use, and various suggestions have been made (refer to a patent document 1).

Patent document 1: Japanese Patent Application Laid Open NO. 2004-294755

### DISCLOSURE OF INVENTION

### Subject to be Solved by the Invention

However, for example, according to the technology disclosed in the patent document 1 described above, the text related to the utterance for registration has to be inputted with a keyboard or the like in the registration, so it is hard to say it is convenient. Moreover, in each registration, it is required to check utterance information to be newly registered, against some check information, to thereby selectively perform whether to make an utterance again or register the utterance, in accordance with the extent of similarity between the utterance information and the check information. Thus, there is such a technical problem that the processing is complicated, to thereby complicate a user's operation as well.

In addition, in any of the conventional technologies, an external noise is mixed in the utterance at the stage of registration, or a registered utterance model becomes unreliable when the speaker makes the utterance without repeatability despite the user's intent (e.g. a voice flips into falsetto or quavers). Thus, a final speaker recognition accuracy falls to the extent that it cannot be ignored. Alternatively, in order to avoid this, a registration operation is required to be performed many times, which causes such a problem that the registration itself becomes hard in practice.

In view of the aforementioned problems, it is therefore an object of the present invention to provide a speaker model registering apparatus and method in a speaker recognition system in which processing on a computer and a user's operation are relatively simple, in registering a text related to speaker recognition, and the speaker recognition system provided with such a speaker model registering apparatus, and a computer program which makes a computer function as such a speaker model registering apparatus.

### Means for Solving the Subject

### (Speaker Model Registering Apparatus in Speaker Recognition System)

The above object of the present invention can be achieved by a speaker model registering apparatus for registering a speaker model for speaker recognition in a speaker recognition system, the speaker model registering apparatus provided with: an obtaining device for obtaining utterances n+α times (wherein n is an integral of 2 or more and α is an integer of 1 or more); a calculating device for calculating speaker models, with the obtained n times of utterances as utterances for registration; a checking device for checking the calculated speaker models, with the obtained α times of utterances as utterances for checking; and a registering device for registering a speaker model in which a result of the checking satisfies a predetermined criterion, of the checked speaker models, as a speaker model for the speaker recognition.

According to the speaker model registering apparatus of the present invention, the registration is performed in the following manner at a stage of registering the speaker model in the speaker recognition system.

That is, in its operation, firstly, the utterances are obtained by the obtaining device equipped with a microphone, a processor, a memory and the like; for example, audio extraction of extracting an audio portion related to a speaker of an audio signal from the microphone and further calculation of a feature quantity from the extracted audio portion are performed. Here, in particular, the utterances are obtained n+α times by letting the speaker utter the same text repeatedly. Here, the “utterance” indicates audio or audio information which is used at any of the stages throughout the whole process of speaker recognition and which is related to the text uttered by the speaker as being a user.

Then, by the calculating device equipped with a processor, a memory, and the like, the n times of utterances obtained are selected as the utterances for registration, and then the speaker models are calculated. Here, the “utterances for registration” mean what are used for registration of the utterances. The utterances for registration only need to be used at least for registration, and as a result, they are not limited to the utterances used in the effective registration.

Then, by the checking device equipped with a processor, a memory, and the like, the α times of utterances obtained by the obtaining device are selected as the utterances for checking, and the speaker models calculated in the above manner are checked. Here, the “utterances for checking” mean what are used as a criterion for checking of the utterances, i.e. a comparative target or comparative criterion. The utterances for checking only need to be used at least for checking, and as a result, they are not limited to the utterances used in the effective checking. In particular, in the present invention, the utterances for checking here are used at a registration step, whereas conventionally the utterances for checking are not used in the actual speaker recognition.

Incidentally, the calculating device selects the obtained n times of utterances as the utterances for registration, passively or actively, and the checking device selects the obtained α times of utterances as the utterances for checking, passively or actively. Here, “passively” particularly means that the calculating device and the checking device do not operate actively at all with regard to which to select, for example, such as selecting the first n times (e.g. the first three times) of utterances as the utterances for registration in accordance with a predetermined rule, and selecting the utterances after the n times up to the last time (e.g. only the fourth one), i.e. the α times of utterances, as the utterances for checking. On the other hand, “actively” means the case where the calculating device and the checking device operate actively with regard to which to select, in other words, the case where the selection is performed with some selection operation including a systematic or trial-and-error operation, such as selecting the n times or α times of utterances when a relatively good checking result is obtained in the end, as the utterances for registration or utterances for checking.

Then, by the registering device equipped with a processor, a memory, a database, and the like, the speaker model in which the checking result by the checking device satisfies the predetermined criterion is registered as the speaker model for speaker recognition. In other words, the speaker model in which the checking result does not satisfy the predetermined criterion is not registered as the speaker model for speaker recognition.

Consequently, according to the present invention, as often seen in practice, even if the obtainment of the utterances repeatedly performed does not go well in all times due to a noise mixed in the utterance by the speaker or a failure of the utterance itself by the speaker, it is possible to avoid such a situation that the registration operation is repeated, extremely efficiently, or it is possible to avoid the registration of the low-reliability speaker model, extremely certainly. Therefore, it is possible to perform the speaker recognition which is extremely reliable in the speaker recognition system, through the relatively simple process on the apparatus side and the relatively simple operation based on the utterances by the speaker as being the user.

In one aspect of the speaker model registering apparatus in the speaker recognition system of the present invention, the registering device performs the registration as the speaker model for the speaker recognition, if the speaker model can be accepted as a speaker oneself β times or more (wherein β is an integer of 1 or more but not exceeding α) of the α times, as the predetermined criterion.

According to this aspect, if the speaker model can be accepted as the speaker oneself β times or more of the α times, it is registered as the speaker model for speaker recognition by the registering device. In contrast, if the speaker model cannot be accepted as the speaker oneself β times or more of the α times, it is not registered as the speaker model for speaker recognition by the registering device. The judgment of whether or not the result of the checking satisfies the predetermined criterion may be performed by the registering device, or by the checking device. Therefore, the registering device certainly allows the registration of the reliable speaker model.

In another aspect of the speaker model registering apparatus in the speaker recognition system of the present invention, it is further provided with a requesting device for discarding the checked speaker models and requesting the obtainment of the utterances by the obtaining device, if the registering device does not perform the registration as the speaker model for the speaker recognition or if the result of the checking does not satisfy the predetermined criterion.

According to this aspect, if the registering device does not perform the registration as the speaker model for the speaker recognition or if the result of the checking does not satisfy the predetermined criterion, the checked speaker models are discarded and then the obtainment of the utterances by the obtaining device is requested by the requesting device equipped with a display apparatus, an audio output apparatus, a controller, a processor, a memory, and the like. For example, the utterances are requested again to the speaker as being the user, through display output on a display screen and audio output in a sound field in front of the speaker model registering apparatus. Therefore, it is possible to certainly register the reliable speaker model by the registering device, while avoiding the registration of the low-reliability speaker model.

Alternatively, in another aspect of the speaker model registering apparatus in the speaker recognition system of the present invention, the calculating device changes a selection manner in selecting the utterances for registration from the utterances obtained n+α times and performs the calculation again, if the registering device does not perform the registration as the speaker model for the speaker recognition or if the result of the checking does not satisfy the predetermined criterion.

According to this aspect, if the registering device does not perform the registration as the speaker model for the speaker recognition or if the result of the checking does not satisfy the predetermined criterion, a combination of what are selected as the utterances for registration from the utterances obtained n+α times, i.e. the n+α utterances, is changed, and the speaker model is re-calculated by the calculating device. If so, even if there is a noise or the like mixed in some utterance, it is possible to reduce or exclude an adverse effect on the result of the calculating and checking of the speaker model, caused by the noise or the like, by changing the selection manner of selecting the utterances for registration and staring over from the calculation of the speaker model. As described above, it is possible to register the reliable speaker model by the registering device, while excluding the utterance by the speaker when a noise is mixed, or the utterance when the utterance itself fails, and while efficiently avoiding the repeat of the operations and processes associated with the obtainment of the utterances.

Alternatively, in another aspect of the speaker model registering apparatus in the speaker recognition system of the present invention, the checking device changes a selection manner in selecting the utterances for checking from the utterances obtained n+α times and performs the calculation again, if the registering device does not perform the registration as the speaker model for the speaker recognition or if the result of the checking does not satisfy the predetermined criterion.

According to this aspect, if the registering device does not perform the registration as the speaker model for the speaker recognition or if the result of the checking does not satisfy the predetermined criterion, what are selected as the utterances for checking from the utterances obtained n+α times, i.e. the n+α utterances, are changed, and the checking is performed again by the checking device. If so, even if there is a noise or the like mixed in some utterance, it is possible to reduce or exclude an adverse effect on the result of the checking, caused by the noise or the like, by changing the selection manner of selecting the utterances for checking and staring over from the checking of the utterances. As described above, it is possible to register the reliable speaker model by the registering device, while excluding the utterance by the speaker when a noise is mixed, or the utterance when the utterance itself fails, and while efficiently avoiding the repeat of the operations and processes associated with the obtainment of the utterances.

Alternatively, in another aspect of the speaker model registering apparatus in the speaker recognition system of the present invention, the calculating device changes a selection manner in selecting the utterances for registration from the utterances obtained n+α times and calculates a plurality of speaker models, and the registering device registers the speaker model with the best one of the corresponding plurality of results of the checking, of the calculated plurality of speaker models.

According to this aspect, regardless of whether or not the registration succeeds and the result of the checking, a combination of what are selected as the utterances for registration from the utterances obtained n+α times, i.e. the n+α utterances, is changed, and the plurality of speaker models are calculated by the calculating device. If so, even if there is a noise or the like mixed in some utterance, it is possible to reduce or exclude an adverse effect on the result of the calculation and checking of the speaker model, caused by the noise or the like, by adopting the case where the selection manner of selecting the utterances for registration is changed to thereby calculate the speaker model without a problem. As described above, it is possible to register the reliable speaker model by the registering device, while excluding the utterance by the speaker when a noise is mixed, or the utterance when the utterance itself fails, and while efficiently avoiding the repeat of the operations and processes associated with the obtainment of the utterances.

Alternatively, in another aspect of the speaker model registering apparatus in the speaker recognition system of the present invention, the calculating device changes a selection manner in selecting the utterances for registration from the utterances obtained n+α times and performs the checking in a plurality of ways, and the registering device registers the checked speaker models, if a statistic or at least one of the results of the checking performed in the plurality of ways satisfies the predetermined criterion.

According to this aspect, regardless of whether or not the registration succeeds and the result of the checking, what are selected as the utterances for checking from the utterances obtained n+α times, i.e. the n+α utterances, are changed, and the checking is performed in the plurality of ways by the checking device. If so, even if there is a noise or the like mixed in some utterance, it is possible to reduce or exclude an adverse effect on the result of the calculation and checking of the speaker model, caused by the noise or the like, by adopting the case where the selection manner of selecting the utterances for checking is changed to thereby perform the checking without a problem. As described above, it is possible to register the reliable speaker model by the registering device, while excluding the utterance by the speaker when a noise is mixed, or the utterance when the utterance itself fails, and while efficiently avoiding the repeat of the operations and processes associated with the obtainment of the utterances.

(Speaker Recognition System)

The above object of the present invention can be also achieved by one speaker recognition system provided with: the speaker model registering apparatus describe above (including its various aspects); and a recognizing device for recognizing the utterances by an arbitrary speaker, on the basis of the registered speaker model.

According to the one speaker recognition system of the present invention, since it is provided with the speaker model registering apparatus of the present invention describe above, it is possible to perform the speaker recognition which is extremely reliable, through the relatively simple registration operation or registration manipulation.

The above object of the present invention can be also achieved by another speaker recognition system provided with: the speaker model registering apparatus describe above (including its various aspects), the checking device functioning even as a recognizing device for recognizing the utterances by an arbitrary speaker, on the basis of the registered speaker model.

According to the another speaker recognition system of the present invention, since it is provided with the speaker model registering apparatus of the present invention describe above, it is possible to perform the speaker recognition which is extremely reliable, through the relatively simple registration operation or registration manipulation. Moreover, the checking device used in the registration also functions as the recognizing device used in the recognition, so that the system construction can be simplified, which is extremely useful.

In one aspect of the one or another speaker recognition system of the present invention, the recognizing device performs the recognition on the basis of similarity based on the registered speaker model for the utterances by the arbitrary speaker.

According to this aspect, it is possible to perform the speaker recognition which is extremely reliable by performing the recognition using various recognition technologies based on the similarity.

(Speaker Model Registering Method in Speaker Recognition System)

The above object of the present invention can be also achieved by a speaker model registering method of registering a speaker model for speaker recognition in a speaker recognition system, the speaker model registering method provided with: an obtaining process of obtaining utterances n+α times (wherein n is an integral of 2 or more and α is an integer of 1 or more); a calculating process of calculating speaker models, with the obtained n times of utterances as utterances for registration; a checking process of checking the calculated speaker models, with the obtained α times of utterances as utterances for checking; and a registering process of registering a speaker model in which a result of the checking satisfies a predetermined criterion, of the checked speaker models, as a speaker model for the speaker recognition.

According to the speaker model registering method in the speaker recognition system, of the present invention, as in the speaker model registering apparatus of the present invention described above, even if the obtainment of the utterances repeatedly performed does not go well in all times due to a noise mixed in the utterance by the speaker or a failure of the utterance itself by the speaker, it is possible to avoid such a situation that the registration operation is repeated, extremely efficiently, or it is possible to avoid the registration of the low-reliability speaker model, extremely certainly.

Incidentally, even the speaker model registering method can employ the same various aspects as those of the speaker model registering apparatus of the present invention described above.

(Computer Program)

The above object of the present invention can be also achieved by a computer program making a computer, which is provided for a speaker model registering apparatus for registering a speaker model for speaker recognition in a speaker recognition system, as: an obtaining device for obtaining utterances n+α times (wherein n is an integral of 2 or more and α is an integer of 1 or more); a calculating device for calculating speaker models, with the obtained n times of utterances as utterances for registration; a checking device for checking the calculated speaker models, with the obtained a times of utterances as utterances for checking; and a registering device for registering a speaker model in which a result of the checking satisfies a predetermined criterion, of the checked speaker models, as a speaker model for the speaker recognition.

According to the computer program of the present invention, the aforementioned speaker model registering apparatus of the present invention can be embodied relatively readily, by loading the computer program from a recording medium for storing the computer program, such as a CD-ROM (Compact Disc-Read Only Memory), a DVD-ROM (DVD Read Only Memory) or the like, into the computer, or by downloading the computer program into the computer via a communication device. By this, as in the speaker model registering apparatus of the present invention described above, even if the obtainment of the utterances repeatedly performed does not go well in all times due to a noise mixed in the utterance by the speaker or a failure of the utterance itself by the speaker, it is possible to avoid such a situation that the registration operation is repeated, extremely efficiently, or it is possible to avoid the registration of the low-reliability speaker model, extremely certainly.

Incidentally, even the computer program can employ the same various aspects as those of the speaker model registering apparatus of the present invention described above.

The above object of the present invention can be also achieved by a computer program product in a computer-readable medium for tangibly embodying a program of instructions executable by a computer provided in a speaker model registering apparatus for registering a speaker model for speaker recognition in a speaker recognition system, the computer program product making the computer function as: an obtaining device for obtaining utterances n+α times (wherein n is an integral of 2 or more and α is an integer of 1 or more); a calculating device for calculating speaker models, with the obtained n times of utterances as utterances for registration; a checking device for checking the calculated speaker models, with the obtained α times of utterances as utterances for checking; and a registering device for registering a speaker model in which a result of the checking satisfies a predetermined criterion, of the checked speaker models, as a speaker model for the speaker recognition.

According to the computer program product of the present invention, the speaker model registering apparatus of the present invention described above can be embodied relatively readily, by loading the computer program product from a recording medium for storing the computer program product, such as a ROM (Read Only Memory), a CD-ROM, a DVD-ROM, a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the speaker model registering apparatus of the present invention described above.

As explained above in details, according to the speaker model registering apparatus of the present invention, it is provided with the calculating device, the checking device, and the registering device. According to the speaker model registering method of the present invention, it is provided with the calculating process, the checking process, and the registering process. Thus, it is possible to avoid such a situation that the registration operation is repeated, extremely efficiently, or it is possible to avoid the registration of the low-reliability speaker model, extremely certainly. According to the speaker recognition system of the present invention, it is provided with the speaker model registering apparatus of the present invention. Thus, it is possible to perform the speaker recognition which is extremely reliable, through the relatively simple registration operation or registration manipulation. Moreover, according to the computer program of the present invention, it makes a computer function as the calculating device, the checking device, and the registering device. Thus, the speaker model registering apparatus of the present invention can be established, relatively easily.

These effects and other advantages of the present invention will become more apparent from the embodiments explained below.

### BRIEF DESCRIPTION OF DRAWINGS

FIG. 1 is a block diagram conceptually showing the basic structure of a speaker model registering apparatus in a speaker registration system, in a first embodiment of the present invention.

FIG. 2 is a block diagram conceptually showing the basic structure of a speaker model registering apparatus in a speaker registration system, in a second embodiment.

FIG. 3 is a flowchart showing the operation processes of the speaker model registering apparatus in the speaker registration system, in the second embodiment.

FIG. 4 is a flowchart showing the operation processes of a speaker model registering apparatus in a speaker registration system, in a third embodiment.

FIG. 5 is a flowchart showing the operation processes of a speaker model registering apparatus in a speaker registration system, in a fourth embodiment.

FIG. 6 is a flowchart showing the operation processes of a speaker model registering apparatus in a speaker registration system, in a fifth embodiment.

FIG. 7 is a flowchart showing the operation processes in speaker recognition in a speaker registration system, in a sixth embodiment.

### DESCRIPTION OF REFERENCE CODES

1 speaker recognition system
10 speaker model registering apparatus
13 obtaining device
20 calculation device
30 check device
40 registration device
50 requesting device
132 microphone
142 audio portion extraction device
201 feature quantity calculation device
202 speaker model calculation device
30 check device
41 verification/registration device
45 speaker model database
52 display screen

### BEST MODE FOR CARRYING OUT THE INVENTION

Hereinafter, the best mode for carrying out the present invention will be explained in each embodiment in order with reference to the drawings.

### (1) First Embodiment

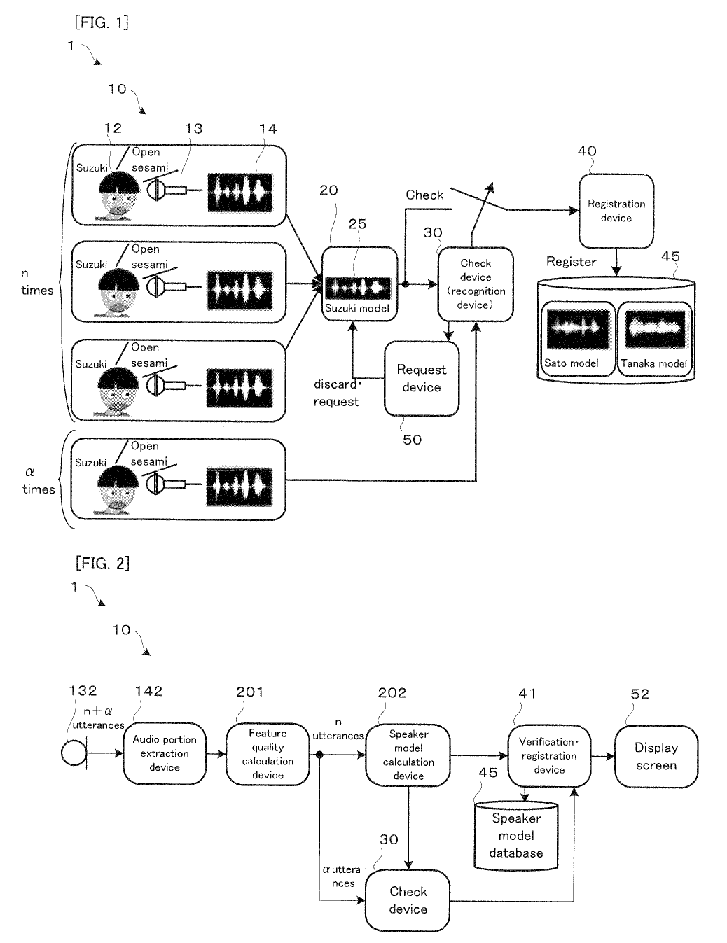

With reference to FIG. 1, an explanation will be given on the structure and basic operation of a speaker model registering apparatus in a speaker registration system, in a first embodiment. FIG. 1 is a block diagram conceptually showing the basic structure of the speaker model registering apparatus in the speaker registration system, in the first embodiment of the present invention.

In FIG. 1, a speaker model registering apparatus 10 in a speaker registration system 1 in this embodiment is provided with: an obtaining device 13 as one example of the “obtaining device” of the present invention; a calculation device 20 as one example of the “calculating device” of the present invention; a check device 30 as one example of the “checking device” and the “recognizing device” of the present invention; a registration device 40 as one example of the “registering device” of the present invention; and a requesting device 50 as one example of the “requesting device” of the present invention.

The obtaining device 13 includes audio input equipment, such as a microphone. The obtaining device 13 obtains utterances (actually, waveform data 14 of the utterances) of a keyword (e.g. “open sesame”), arbitrarily set by a user 12 (e.g. Mr. Suzuki) who is a speaker, n+α times when the speaker's registration is performed, and stores them into a memory or the like. Here, n is the number of utterances required for calculating and registering the number of utterances for registration, i.e. a speaker model 25, and α is the number of utterances for checking, i.e. the number of utterances required to check whether or not the calculated speaker model 25 is suitable. For example, in FIG. 1, the speaker model 25 (e.g. Suzuki model) is calculated on the basis of n=3, namely, three times of utterances, and the speaker model 26 is checked on the basis of α=1, namely, one time of utterance for checking.

The calculation device 20 is logically established in accordance with a program, within a computer provided with a processor, a memory, and the like. The calculation device 20 calculates the speaker model 25 which captures characteristics when the user 12 (Mr. Suzuki) utters the keyword, on the basis of n times of utterances of the utterances obtained by the obtaining device 13.

The check device 30 is logically established in accordance with a program, within a computer provided with a processor, a memory, and the like. The check device 30 uses α times of utterances excessively uttered by the user 12 (Mr. Suzuki) as the utterance for checking, and checks the utterance for checking against the calculated speaker model 25. For example, the check device 30 checks one utterance for checking of the user 12 (Mr. Suzuki) himself against the calculated speaker model 25. In addition, the check device 20 may function as the recognizing device.

The registration device 40 is logically established in accordance with a program, within a computer provided with a processor, a memory, and the like. The registration device 40 formally registers the speaker model 25 satisfying a predetermined criterion as a result of the checking by the check device 30, of the speaker model 25 calculated by the calculation device 20, as the speaker model 25 for speaker recognition, into a speaker model database 45 established within a large-scale memory apparatus, such as a hard disk apparatus provided for a computer and an optical disc apparatus. For example, after checking one utterance for checking, which is known to be the utterance of the user 12 (Mr. Suzuki) himself in advance, against the calculated speaker model 25, if it is correctly recognized to be Mr. Suzuki himself, then it is verified that the speaker model 25 is suitable or that the speaker model 25 correctly functions, and the speaker model 25 is registered into the speaker model database 45. In the checking, if the utterance of a person except the user, e.g. the utterance of Mr. Sato instead of Mr. Suzuki, is used as the utterance for checking, as a negative control, and if it is recognized not to be the user's, then the speaker model 25 which is more suitable can be registered.

If there is no speaker model 25 satisfying the predetermined criterion as a result of the checking by the check device 30, of the speaker model 25 calculated by the calculation device 20, it is considered that the speaker model 25 calculated by the calculation device 20 or the utterance which is an foundation of the speaker model 25 has something wrong or is unsuitable, and the requesting device 50 requests an utterance for registration to the user 12 again. For example, the requesting device 50 displays a message for request on a display, such as “make an utterance again”, or performs audio output. Then, the process based on the aforementioned construction is performed until the requesting device 50 no longer requests it to the user 12, in other words, until the speaker model 25 for speaker recognition is registered.

In addition, when the speaker recognition system 1 provided with the speaker model registering apparatus 10 described above performs the speaker recognition, the following recognition device 30 may be further provided.

The recognition device 30 is logically established in accordance with a program, within a computer provided with a processor, a memory, and the like. In the speaker recognition, the recognition device 30 checks the utterance of an arbitrary speaker who requires recognition (the speaker herein, i.e. the user 12, is not limited to a registrant who registers the speaker model 25; for example, the speaker includes a third party who pretends to be Mr. Suzuki) against the registered speaker model 25, to thereby recognize whether or not the arbitrary speaker who requires recognition is the speaker of the registered speaker model 25. Specifically, as a result of the checking, if the similarity or the like satisfies the predetermined criterion, it is recognized that the arbitrary speaker who requires recognition is the speaker of the registered speaker model 25, and if not, it is recognized that the arbitrary speaker is not the speaker.

As described above, according to the speaker model registering apparatus 10 in the speaker recognition system 1 constructed as shown in FIG. 1, the speaker model 25 for speaker recognition is preferably registered. At this time, as often seen in practice, even if the obtainment of the utterances repeatedly performed does not go well in all times due to a noise mixed in the utterance by the user 12 or a failure of the utterance itself by the user 12, it is possible to avoid such a situation that the registration operation is repeated, extremely efficiently, or it is possible avoid that the speaker model whose reliability is low, extremely certainly. Therefore, in the end, it is possible to perform the speaker recognition which is extremely reliable, in the speaker recognition system, through the relatively simple process on the apparatus side and the relatively simple operation by the user 12.

### (2) Second Embodiment

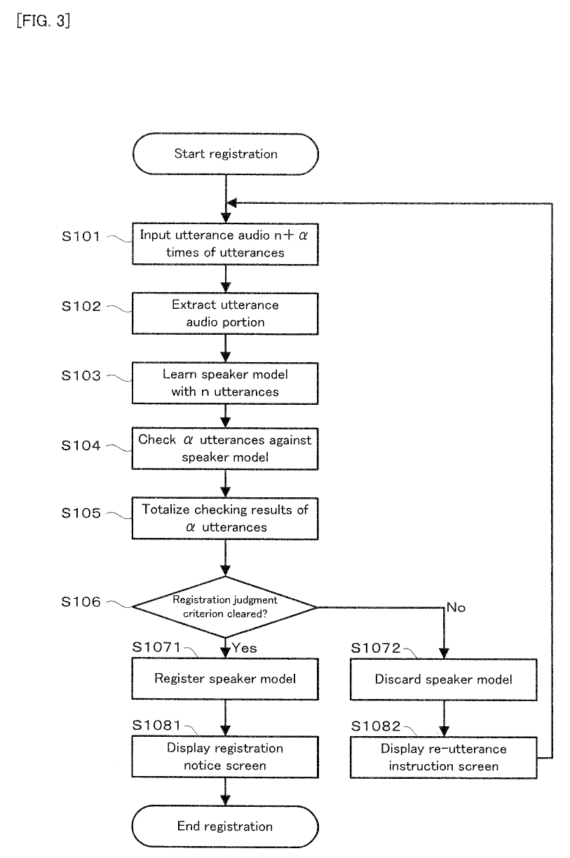

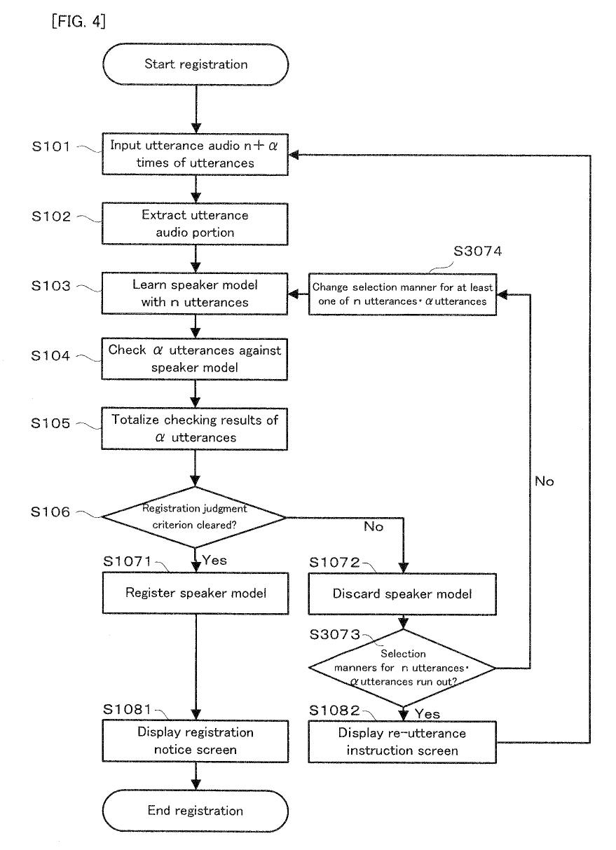

With reference to FIG. 2 and FIG. 3, an explanation will be given on the structure and basic operation of a speaker model registering apparatus 10 in a speaker registration system 1, in a second embodiment. FIG. 2 is a block diagram conceptually showing the basic structure of the speaker model registering apparatus in the speaker registration system, in the second embodiment. Incidentally, in FIG. 2 and FIG. 3, the same structure as that of the first embodiment shown in FIG. 1 described above carries the same numerical reference, and the explanation thereof will be omitted as occasion demands.

In FIG. 2, a microphone 132 is equipment for converting utterances into respective electric signals and inputting them into the speaker recognition system 1 when a user 2 utters the keyword n times.

An audio portion extraction device 142 is logically established in accordance with a program, within a computer provided with a processor, a memory, and the like. The audio portion extraction device 142 is an arithmetic apparatus for cutting out an utterance audio portion in which the keyword is uttered, from the converted electric signals of the utterances, by a general audio section detecting method or the like which uses a difference in power between a background noise and an audio utterance section.

A feature quantity calculation device 201 is logically established in accordance with a program, within a computer provided with a processor, a memory, and the like. The feature quantity calculation device 201 converts the inputted utterance audio portion into a feature quantity. The feature quantity is an arithmetic apparatus converted by MFCC (Mel Frequency Cepstrum Coefficient), LPC (Linear Predictive Coding) cepstrum, or the like. Then, if there are a plurality of feature quantities, one portion thereof (e.g. by n times of feature quantities) is transmitted to a speaker model calculation device 202, and another portion thereof (e.g. by α times of feature quantities) is transmitted to a verification/registering device 41.

The speaker model calculation device 202 is logically established in accordance with a program, within a computer provided with a processor, a memory, and the like. The speaker model calculation device 202 is an arithmetic apparatus for calculating and learning the speaker model for checking, with the n times of feature quantities calculated on the feature quantity calculation device 201. Here, the speaker model is expressed as a speaker template in various audio recognition algorithms, such as speaker HMM (Hidden Markov Model) and DP (Dynamic Programming) matching.

The check device 30, as in the case of the first embodiment, is an arithmetic apparatus for checking the speaker model calculated on the speaker model calculation device 202 against the feature quantity for checking. Incidentally, as the similarity, likelihood or a reciprocal of distance scale is used. If the reciprocal of distance scale is used as the similarity, it is necessary to change the controlling method, as occasion demands, because of the reciprocal. Specifically, an inequality sign is reversed in the comparison with the predetermined threshold value on the verification/registering device 41.

The verification/registering device 41 is logically established in accordance with a program, within a computer provided with a processor, a memory, and the like. The verification/registering device 41 is an arithmetic apparatus and a recording apparatus for comparing the similarity calculated on the check device 30 with a predetermined threshold value, to thereby verify whether or not each of the α times of feature quantities for checking is recognized to be the feature quantity of user corresponding to the calculated speaker model, using the calculated speaker model, i.e. whether or not the calculated speaker model may be registered into the speaker model database 45. Then, the verification/registering device 41 registers the speaker model in which it is verified that the speaker model may be registered, into the speaker model database 45.

The display screen 52 is display equipment, such as a liquid crystal display, for displaying a verification result or a request message.

Using FIG. 3, an explanation will be given on the process when the speaker model for speaker recognition is registered by the speaker model registering apparatus 10 constructed as in FIG. 2. FIG. 3 is a flowchart showing the operation processes of the speaker model registering apparatus in the speaker registration system, in the second embodiment.

In FIG. 3, firstly, for example, if the registration is started by the user pressing a start button or the like, a notice to request the n+α times of utterances of the keyword toward the microphone 132 is given to the user on a display screen 102 or the like. In response to this, the n+α times of utterances are inputted to the speaker model registering apparatus 10 through the microphone 132 (step S101). Incidentally, before starting the registration, utterances except the keyword, such as “let's see”, may be taught and avoided by text display on the screen or guidance audio or the like.

Each of the utterance audio portions of the n+α times of utterances inputted is extracted by the audio portion extraction device 142 (step S102).

Using the utterance audio portions associated with the n+α times of utterances, the user's speaker model is calculated and leaned (step S103). Specifically, each of the utterance audio portions of the n+α times of utterances transmitted is converted to respective one of the feature quantities by the feature quantity calculation device 201. Then, of the feature quantities associated with the n+α times of utterances, the feature quantities associated with the n times of utterances (or utterances for registration) are transmitted to the speaker model calculation device 202, to thereby calculate the user's utterance model. The feature quantities associated with the rest of α times of utterances (or utterances for checking) are transmitted to the check device 30 as those for checking.

Then, the calculated user's speaker model is checked against each of the feature quantities associated with the α times of utterances for checking, by the check device 30 (step S104). For example, the similarity is calculated between the calculated user's speaker model and each of the feature quantities associated with the α times of utterances for checking.

A checking result of the similarity between each of the utterances for checking and the user's speaker model, calculated as described above, is totalized by the verification/registration device 41 (step S105), and it is judged whether or not the totalized result satisfies a registration judgment criterion, in other words, whether or not the calculated user's speaker model may be registered (step S106). For example, it is judged whether or not the number of utterances that are accepted as the user's by the calculated user's speaker model, of the α times of utterances for checking, is greater than or equal to β (β is 1 or more but not exceeding α). Specifically, it is judged whether or not the number of utterances in which the similarity for the calculated user's speaker model exceeds a predetermined similarity threshold value, of the α times of utterances for checking, is β. Here, the “predetermined similarity threshold value” is the similarity corresponding to the registration judgment criterion, and its value may have a margin. However, a too large margin may cause such a situation that a person except the user is recognized to be the user himself. On the other hand, a too small margin may cause such a situation that even the user himself is not recognized, depending on the user's health condition or the like. Therefore, in view of the above, the “predetermined similarity threshold value” may be obtained by experiments or simulations, as the similarity that can fully distinguish between the user's utterances and another person's utterance, in practice.

Here, if it is judged that the totalized result satisfies the registration judgment criterion (the step S106: Yes), the verification/registration device 41 registers the calculated user's speaker model into the speaker model database 45 (step S1071), and a notice to indicate that is given to the user through the display screen 52 (step S1081), and the registration is ended.

On the other hand, if it is not judged that the totalized result satisfies the registration judgment criterion (the step S106: No), the requesting device 50 discards the calculated user's speaker model (step S1072), and gives a notice to request re-registration to the user through the display screen 52 (step S1082). Then, the above process is repeated until the speaker model is registered.

Since the speaker model registering apparatus 10 in the speaker recognition system 1 operates as described above, the speaker model is properly registered. In particular, the utterances for registration and the utterances for checking are firstly obtained, and the speaker recognition performance of the speaker model is verified, which is learned with the utterances for registration before being learned with the utterances for checking. Moreover, an extra operation is not imposed on the user, such as inputting a keyword text in addition to uttering audio. In addition, even if there is a noise mixed in the first utterance, it can be detected without man's operation, such as the user or a manager's confirmation. Thus, it is extremely useful in practice.

### (3) Third Embodiment

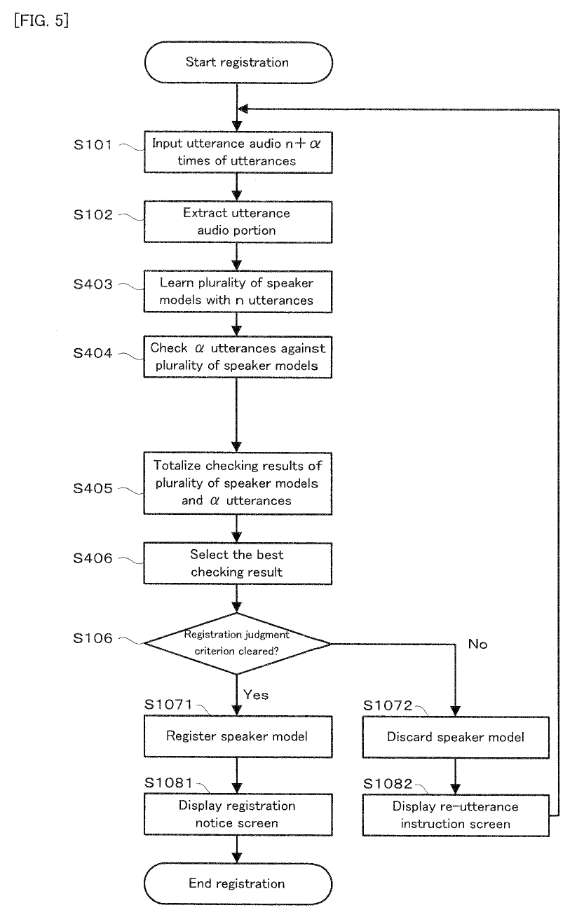

Next, with reference to FIG. 4 in addition to FIG. 2 and FIG. 3, an explanation will be given on the basic operation of a speaker model registering apparatus 10 in a speaker registration system 1, in a third embodiment. FIG. 4 is a flowchart showing the operation processes of the speaker model registering apparatus in the speaker registration system, in the third embodiment. Incidentally, in FIG. 4, the same structure or process as that of the aforementioned drawings carries the same numerical reference, and the explanation thereof will be omitted as occasion demands.

The flowchart in FIG. 4 differs from the flowchart in FIG. 3, mainly in the processes after the speaker model is discarded (the step S1072).

Specifically, if the speaker model is discarded (the step S1072), re-utterance is not requested soon, but it is confirmed whether or not selection manners of selecting the n utterances and the α utterances run out (step S3073). For example, a plurality of selection manners are determined in advance, and it may be checked whether or not all the selection manners have been tried.

Here, if the selection manners runs out (the step S3073: Yes), a notice to request re-registration is given to the user through the display screen 52 (the step S1082). However, even if all the selection manners are not tried, if there is no utterance that clears the registration judgment criterion at a certain stage, the utterance may be requested as the originally inputted utterance is not suitable.

On the other hand, if the selection manners do not run out (the step S3073: No), the selection manner to select the n times of utterances for registration is changed, or the selection manner to select the α times of utterances for checking is changed, and the speaker model is learned again (step S3074).

As explained with reference to FIG. 4 in addition to FIG. 2 and FIG. 3, according to the speaker model registering apparatus 10 in the speaker recognition system 1 in the embodiment, since, obviously, the speaker model is properly registered, and the inputted utterances are reused, so that the user's load is reduced, which is extremely useful in practice.

### (4) Fourth Embodiment

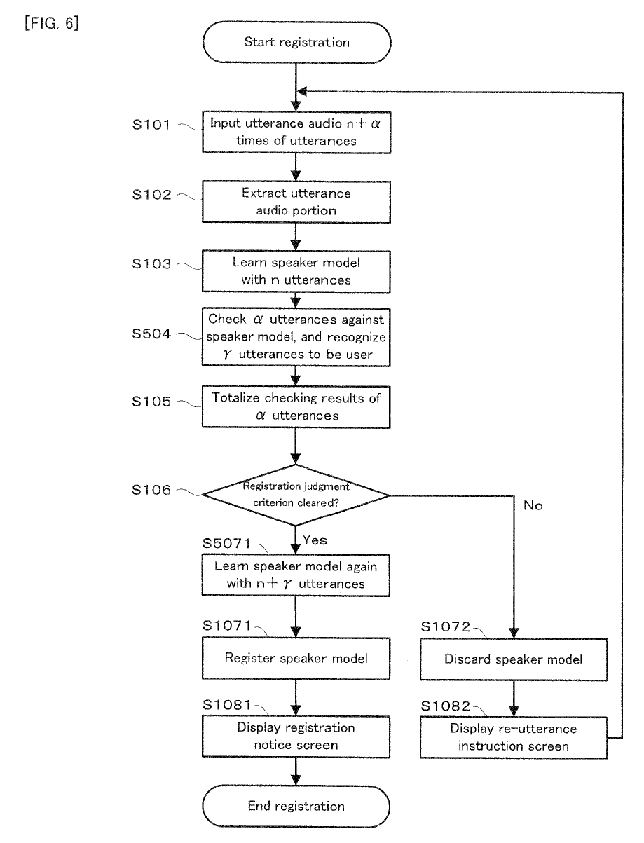

Next, with reference to FIG. 5 in addition to FIG. 2 and FIG. 3, an explanation will be given on the basic operation of a speaker model registering apparatus 10 in a speaker registration system 1, in a fourth embodiment. FIG. 5 is a flowchart showing the operation processes of the speaker model registering apparatus in the speaker registration system, in the fourth embodiment. Incidentally, in FIG. 5, the same structure or process as that of the aforementioned drawings carries the same numerical reference, and the explanation thereof will be omitted as occasion demands.

The flowchart in FIG. 5 differs from the flowchart in FIG. 3, mainly in the processes between the extraction of the utterance audio portions of the utterances inputted (the step S102) and the judgment of whether or not the registration judgment criterion is cleared (the step S106).

Specifically, firstly, using the utterance audio portions associated with the n+α times of utterances, a plurality of user's speaker models are calculated and leaned (step S403).

Then, each of the plurality of user's speaker models calculated is checked against respective one of the feature quantities associated with the α times of utterances for checking, by the check device 30 (step S404).

A checking result of the similarity between each of the utterances for checking and respective one of the plurality of user's speaker model, calculated as described above, is totalized by the verification/registration device 41 (step S405), and the speaker model with the best checking result of the plurality of speaker models is selected (step S406). For example, the speaker model with the largest average value of the similarities for the utterances for checking that are recognized to be the user's is selected as the speaker model with the best checking result. At this time, instead of the average value, another scale may be determined in advance and employed, such as a maximum value, a minimum value, or a median.

Then, it is judged whether or not the totalized result associated with the speaker model with the best checking result satisfies the registration judgment criterion (the step S106).

As explained with reference to FIG. 5 in addition to FIG. 2 and FIG. 3, according to the speaker model registering apparatus in the speaker recognition system in the embodiment, it selects the best one from the plurality of speaker models. Thus, the reliable speaker model can be selected and registered by the verification/registration device 41, while excluding the utterance of the speaker when a noise is mixed, or the utterance when the utterance itself fails, and while efficiently avoiding the repeat of the operations and processes associated with the obtainment of the utterances, for example.

### (5) Fifth Embodiment

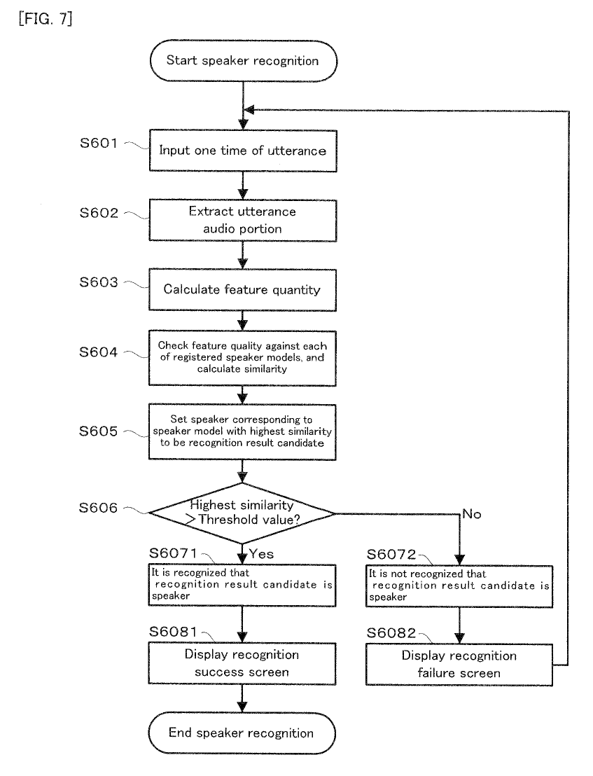

Next, with reference to FIG. 6 in addition to FIG. 2 and FIG. 3, an explanation will be given on the basic operation of a speaker model registering apparatus 10 in a speaker registration system 1, in a fifth embodiment. FIG. 6 is a flowchart showing the operation processes of the speaker model registering apparatus in the speaker registration system, in the fifth embodiment. Incidentally, in FIG. 6, the same structure or process as that of the aforementioned drawings carries the same numerical reference, and the explanation thereof will be omitted as occasion demands.

The flowchart in FIG. 6 differs from the flowchart in FIG. 3, mainly in that when the speaker model satisfies the registration judgment criterion in the verification of the speaker model, the speaker model is learned and registered again on the basis of n+γ times of utterances for registration, instead of γ times of utterances recognized as the user's on the basis of the speaker model.

Specifically, it is assumed that after the speaker model is calculated on the basis of the n times of utterances for registration, the speaker model is checked against the α times of utterances for checking, and that the γ times of utterances of them are recognized to be the user's (step S504).

Moreover, it is assumed that a checking result of the similarity between each of the utterances for checking and the calculated user's speaker model is totalized by the verification/registration device 41 (the step S105), and that it is judged that the totalized result satisfies the registration judgment criterion (the step S106: Yes).

At this time, the γ times of utterances recognized to be the user's are further added to the n times of utterances for registration, and the speaker model is re-calculated on the speaker model calculation device 202 (step S5071), and in the end, the speaker model based on the n+γ times of utterances is registered.

Incidentally, instead of re-calculating the speaker model calculation device 202 based on the n+γ times of utterances, an adaptive treatment may be performed with the γ times of utterances.

As explained with reference to FIG. 6 in addition to FIG. 2 and FIG. 3, according to the speaker model registering apparatus 10 in the speaker recognition system 1 in the embodiment, the utterance for checking recognized to be the user's is regarded as the speaker model for registration. Thus, the speaker model calculation device 202 can calculate the reliable speaker model or perform the adaptive treatment.

### (6) Sixth Embodiment

Next, with reference to FIG. 7 in addition to FIG. 2, an explanation will be given on the basic operation in the speaker recognition in a speaker registration system 1, in a sixth embodiment. FIG. 7 is a flowchart showing the operation processes in the speaker recognition in the speaker registration system, in the sixth embodiment. In FIG. 7, firstly, if the user or the speaker utters the keyword at least once toward the microphone 132 in the speaker recognition, the uttered audio at this time is picked up (step S601), and the audio utterance section is extracted by the audio portion extraction device 142 (step S602). The extracted audio utterance section is converted to the feature quantity by the feature quantity calculation device 202 and transmitted to the checking device (step S603).

On the check device 30, the transmitted feature quantity is checked against each speaker model registered by the speaker model registering apparatus 10 in the aforementioned embodiment, and the similarity is calculated in response to each speaker model (step S604). The speaker corresponding to the speaker model with the similarity that is the highest (hereinafter referred to highest similarity) is selected as a recognition result candidate (step S605).

Then, the highest similarity is compared with a threshold value preset to reject another person's utterances with satisfactory accuracy (step S606). If the highest similarity is greater than the threshold value (the step S606: Yes), it is judged to be the corresponding speaker oneself (step S6071), and the result is outputted to the display screen 52 (step S6081).

On the other hand, if the highest similarity is less than the threshold value (the step S606: No), it is not judged to be the corresponding speaker oneself (step S6072), and a recognition failure screen is displayed (step S6082).

Incidentally, even if the recognition result candidate is not selected as described above, it may be judged whether to recognize or reject the speaker by declaring who one in advance by utterances or keyboard input, by narrowing down the speaker models for checking to one model to obtain the similarity and to compared it with the threshold value.

As explained with reference to FIG. 7 in addition to FIG. 2, according to the speaker recognition system 1 in the embodiment, since it is provided with the speaker model registering apparatus 10 in the embodiment described above, it is possible to perform the speaker recognition which is extremely reliable, through the relatively simple registration operation or registration manipulation.

The operation processes shown in the aforementioned embodiments may be realized by operating the speaker recognition system on the basis of a speaker model registering method in the speaker registration system 1, wherein the method is provided with an obtaining process, a calculating process, a checking process, and a registering process. Alternatively, the operation processes may be realized by making a computer provided for the speaker recognition system 1 read a computer program, wherein the speaker recognition system 1 is provided with an obtaining device, a calculating device, a checking device, and a registering device.

The present invention is not limited to the aforementioned embodiment, but various changes may be made, if desired, without departing from the essence or spirit of the invention which can be read from the claims and the entire specification. A speaker model registering apparatus and method in a speaker recognition system, and a computer program, all of which involve such changes, are also intended to be within the technical scope of the present invention.

### INDUSTRIAL APPLICABILITY

The speaker model registering apparatus and method in the speaker recognition system, and the computer program of the present invention can be applied to a speaker model registering apparatus in a speaker recognition system, which is provided for various computer equipment and various electronic electric equipment, such as a car navigation apparatus, a net banking apparatus, an auto-lock apparatus, and a computer's recognizing apparatus, and which performs speaker recognition on the basis of an utterance of a speaker who is a user of the system.

1-12. (canceled)

13. A speaker model registering apparatus for registering a speaker model for speaker recognition in a speaker recognition system, said speaker model registering apparatus comprising: an obtaining device for obtaining utterances n+α times (wherein n is an integral of 2 or more and α is an integer of 1 or more); a calculating device for calculating speaker models, with the obtained n times of utterances as utterances for registration; a checking device for checking the calculated speaker models, with the obtained α times of utterances as utterances for checking; and a registering device for registering a speaker model in which a result of the checking satisfies a predetermined criterion, of the checked speaker models, as a speaker model for the speaker recognition, wherein said registering device performs the registration as the speaker model for the speaker recognition, if the speaker model can be accepted as a speaker oneself β times or more (wherein β is an integer of 1 or more but not exceeding α) of the α times, as the predetermined criterion.

14. The speaker model registering apparatus according to claim 13, further comprising a requesting device for discarding the checked speaker models and requesting the obtainment of the utterances by said obtaining device, if said registering device does not perform the registration as the speaker model for the speaker recognition or if the result of the checking does not satisfy the predetermined criterion.

15. The speaker model registering apparatus according to claim 13, wherein said calculating device changes a selection manner in selecting the utterances for registration from the utterances obtained n+α times and performs the calculation again, if said registering device does not perform the registration as the speaker model for the speaker recognition or if the result of the checking does not satisfy the predetermined criterion.

16. The speaker model registering apparatus according to claim 13, wherein said checking device changes a selection manner in selecting the utterances for checking from the utterances obtained n+α times and performs the calculation again, if said registering device does not perform the registration as the speaker model for the speaker recognition or if the result of the checking does not satisfy the predetermined criterion.

17. The speaker model registering apparatus according to claim 13, wherein said calculating device changes a selection manner in selecting the utterances for registration from the utterances obtained n+α times and calculates a plurality of speaker models, and said registering device registers the speaker model with the best one of the corresponding plurality of results of the checking, of the calculated plurality of speaker models.

18. The speaker model registering apparatus according to claim 13, wherein said calculating device changes a selection manner in selecting the utterances for registration from the utterances obtained n+α times and performs the checking in a plurality of ways, and said registering device registers the checked speaker models, if a statistic or at least one of the results of the checking performed in the plurality of ways satisfies the predetermined criterion.

19. A speaker recognition system comprising:
the speaker model registering apparatus according to claim 13; and a recognizing device for recognizing the utterances by an arbitrary speaker, on the basis of the registered speaker model.

20. A speaker recognition system comprising:
the speaker model registering apparatus according to claim 13, said checking device functioning even as a recognizing device for recognizing the utterances by an arbitrary speaker, on the basis of the registered speaker model.

21. The speaker recognition system according to claim 19, wherein said recognizing device performs the recognition on the basis of similarity based on the registered speaker model for the utterances by the arbitrary speaker.

22. A speaker model registering method of registering a speaker model for speaker recognition in a speaker recognition system, said speaker model registering method comprising: an obtaining process of obtaining utterances n+α times (wherein n is an integral of 2 or more and α is an integer of 1 or more); a calculating process of calculating speaker models, with the obtained n times of utterances as utterances for registration; a checking process of checking the calculated speaker models, with the obtained α times of utterances as utterances for checking; and a registering process of registering a speaker model in which a result of the checking satisfies a predetermined criterion, of the checked speaker models, as a speaker model for the speaker recognition, wherein said registering process performs the registration as the speaker model for the speaker recognition, if the speaker model can be accepted as a speaker oneself β times or more (wherein β is an integer of 1 or more but not exceeding α) of the α times, as the predetermined criterion.

23. A computer program product in a computer-readable medium for tangibly embodying a program of instructions executable by a computer provided in a speaker model registering apparatus for registering a speaker model for speaker recognition in a speaker recognition system, said computer program product making the computer function as:
an obtaining device for obtaining utterances n+α times (wherein n is an integral of 2 or more and α is an integer of 1 or more); a calculating device for calculating speaker models, with the obtained n times of utterances as utterances for registration; a checking device for checking the calculated speaker models, with the obtained α times of utterances as utterances for checking; and a registering device for registering a speaker model in which a result of the checking satisfies a predetermined criterion, of the checked speaker models, as a speaker model for the speaker recognition, wherein said registering device performs the registration as the speaker model for the speaker recognition, if the speaker model can be accepted as a speaker oneself β times or more (wherein β is an integer of 1 or more but not exceeding α) of the α times, as the predetermined criterion.
